(19) United States
(12) Patent Application Publication
(10) Pub. No.: US 2024/0410204 A1
(43) Pub. Date: Dec. 12, 2024

(54) MOTOR VEHICLE LOCK, IN PARTICULAR MOTOR VEHICLE DOOR LOCK

(71) Applicant: KIEKERT AKTIENGESELLSCHAFT, Heiligenhaus (DE)

(72) Inventors: Peter SZEGENY, Engelskirchen (DE); Ömer INAN, Dorsten (DE); Elena SUHOLUTSKAJA, Düsseldorf (DE); Michael SCHOLZ, Essen (DE); Holger SCHIFFER, Meerbusch (DE)

(73) Assignee: KIEKERT AKTIENGESELLSCHAFT, Heiligenhaus (DE)

(21) Appl. No.: 18/699,711

(22) PCT Filed: Sep. 28, 2022
(86) PCT No.: PCT/DE2022/100719

§ 371 Date: Apr. 15, 2024

(30) Foreign Application Priority Data
Oct. 13, 2021 (DE) 10 2021 126 476.6

(51) Int. Cl. E05B 81/68; E05B 85/24; E05B 85/26

(52) U.S. Cl. CPC E05B 81/68; E05B 85/243; E05B 85/26

(57) ABSTRACT

A motor vehicle lock, in particular a motor vehicle door lock, which is equipped with: a locking mechanism consisting substantially of the locking mechanism components of a rotary latch and a pawl; at least one sensor for sensing the position of the rotary latch and the pawl; and at least one sensing element between the sensor and the associated locking mechanism component. The sensing element has a pawl contour and a rotary latch contour for sensing a closed position of the pawl on the one hand and the rotary latch on the other hand. Furthermore, the sensing element is designed to be rotatable relative to an axis. In addition, the sensing element is prestressed in the direction of the locking mechanism by means of a spring. According to the invention, the spring is designed to be stationary and is equipped with a spread-apart spring arm which acts on the sensing element.

The invention relates to a motor vehicle lock, in particular a motor vehicle door lock, with a locking mechanism comprising substantially the locking mechanism components rotary latch and pawl, further with at least one sensor for sensing the position of the rotary latch and the pawl, and with at least one sensing element between the sensor and the associated locking mechanism component, wherein the sensing element is equipped with a pawl contour and a rotary latch contour for sensing a closed position of the pawl on the one hand and the rotary latch on the other hand, wherein further the sensing element is designed to be rotatable relative to an axis, and wherein the sensing element is biased in the direction of the locking mechanism by means of a spring.

The adoption of the different locking positions and in particular a main locking position of a locking mechanism in motor vehicle door locks in particular and their detection is of particular importance. This is because the function of safety components, for example the function of a side airbag, a belt tightener, etc., is usually linked to the main locking position. This aspect is all the more important as motor vehicle doors are often equipped with a closing aid for reasons of comfort or because of their weight, in order to provide motorized support for the closing process of the relevant motor vehicle door, which is initiated manually.

A motor vehicle door lock with a closing drive is described, for example, in DE 10 2009003402 A1. In this case, a closing lever acting on the rotary latch is realized. A closing lever switch is provided to determine the functional position of the closing lever. In addition, a functional position of the pawl can be detected using a pawl switch. In addition, the closing lever acts as a contact member of the closing lever switch that senses a control cam of the rotary latch.

This allows a functional position of the rotary latch to be determined. Due to the different switch positions, the respective functional status of the locking mechanism can be recorded and evaluated using a control unit. However, the associated design and circuitry complexity is high due to the plurality of switches to be queried.

For this reason, the prior art according to U.S. Pat. No. 5,785,364 uses a sensing element that actuates a switch. However, the switch as a sensor is ultimately only layered to query the position of the rotary latch. An additional position query of the pawl is not possible. For this purpose, the contact element has an arm which is biased by the rotary latch to actuate the switch. As a result, only limited statements can be made about the functional positions of the individual locking mechanism components and particularly the pawl.

In another prior art according to DE 103 30 194 A1, the sensing element is designed as an elastically adjustable actuating element or bending element. Both the rotary latch and the pawl are coupled to the actuating element, so that reaching the main latch position of the lock latch only triggers a sensory system together with reaching the main latch position of the pawl. Otherwise, the sensor is in a non-triggered state.

With regard to this prior art, it is noticeable that the elastically adjustable actuating element is designed as an elongated bending element and is clamped on one side at a clamping point in the manner of a bending beam. The bending element itself can be a metal or plastic strip. Such metal or plastic strips are not only subject to ageing effects, but particularly to temperature fluctuations during the operation of such a motor vehicle lock. In practice, this can lead to malfunctions being observed when sensing the closing position of the pawl on the one hand and the rotary latch on the other.

In the generic prior art according to DE 10 2019 107 572 A1, an alternative second variant uses a sensing element designed to rotate relative to an axis. The sensing element has the pawl contour and the rotary latch contour for sensing the closed position of the pawl on the one hand and the closed position of the rotary latch on the other. Each time at least one locking mechanism component deviates from its closed position, the contact element biases the sensor. In contrast to U.S. Pat. No. 5,785,364, the sensing element can therefore also detect a deviation of the pawl from its closed position and ensures that the sensory system is actuated accordingly. As a result, a control unit evaluating the signals from the sensor is comprised of information about the respective state of the locking mechanism.

The design described above has proven itself in principle and is also insensitive to any temperature effects. This is because the sensing element in the second variant described is a shift lever mounted rotatably in the lock case. Although this is designed to be spring-loaded, wherein details of the spring loading are left open. The invention as a whole seeks to remedy this.

The invention is based on the technical problem of further developing a motor vehicle lock and, in particular, a motor vehicle door lock in such a manner that the functional reliability is increased and, in particular, temperature and ageing effects are not observed and a secure position query of both the rotary latch and the pawl is possible with the aid of the sensor.

To solve this technical problem, the invention proposes that the spring preloading the sensing element in the direction of the locking mechanism is designed to be stationary and biases the sensing element with a spread-apart spring arm in a motor vehicle lock of the same type, and in particular a motor vehicle door lock.

The spring is advantageously a spiral spring with a coiled spring portion and two spring arms extending from it. One spring arm is usually designed as a sensing spring arm that acts on the sensing element and the other spring arm is designed as a stop spring arm that rests against a stop. The coiled spring portion is usually attached to a pivot in a lock housing, for example. The lock housing usually also provides the stop for the stop spring arm. For this purpose, the pivot in question and the stop may each be molded onto the lock housing, which is typically made of plastic.

In this manner, perfect position sensing of both the rotary latch and the pawl is already provided and realized. This is because the sensing element interposed between the sensor and the associated locking mechanism component is preloaded in the direction of the locking mechanism with the aid of the fixed spring. The sensing element in question is usually either in contact with both the rotary latch and the locking mechanism as a result of the preload using the spiral spring, or is at a distance from both locking mechanism components. In the first-mentioned case, the sensor is both not energized and energized, namely when the pawl is raised relative to the rotary latch, i.e. does not assume its closed position. The sensor is also biased when the sensing element is at a distance from both the rotary latch and the pawl.

The sensor is generally a (single) sensor which, in connection with the sensing element, provides reliable information about the functional status and particularly the locking position of the locking mechanism component in question. In fact, every time at least one locking mechanism component deviates from its closed position, the sensing element ensures that the (single) sensor is biased.

For this purpose, the sensor may be a tactile sensory system, such as a switch. In principle, however, the sensor can also function as a contactless sensor in the sense of a Hall sensor. In this case, a magnet opposite the Hall sensor may be embedded in the sensing element.

Either way, the overall functional reliability is increased compared to the prior art because the special design of the spring ensures that the sensing element ultimately only assumes the two basic positions, namely in deposit on both locking mechanism components on the one hand and at a distance from both locking mechanism components on the other. The first basic position is then modified to the extent that the sensing element, which can rotate about the axis, can be pivoted in this first basic position into plant contact with both locking mechanism components, namely by the pawl which is not in engagement with the rotary latch and which has consequently left its locking position to be sensed in this case. This leads to an impact on the sensor.

The sensor is also biased when the sensing element assumes its second home position or home position at a distance from both the rotary latch and the pawl. According to the invention, this makes it possible to reliably detect any deviation of at least one locking mechanism component from its closed position using the (single) sensor. Any temperature and ageing effects do not play a role here. These are the main advantages.

In an advantageous embodiment, the sensing element is designed as a multi-arm lever rotatable about the axis with at least one contour arm and sensor arm. The contour arm generally has the pawl contour and the rotary latch contour. In contrast, the sensor arm is configured to interact with the sensor. The axis for the sensing element, which is designed as a multi-arm lever, is generally defined by a bolt or pivot, which may be molded onto the previously mentioned plastic lock housing for this purpose. In principle, however, the bolt or pivot in question can also be connected to a lock case supporting the locking mechanism.

In a particularly preferred variant, the multi-arm lever has a slotted hole in the area of the axis in question. The bolt or pivot described above, which defines the axle, is therefore inserted into this slotted hole. As a result of this slotted hole recess, the multi-arm lever can perform not only rotary movements but also a lever displacement in the longitudinal direction of the slotted hole recess. In other words, the slotted hole recess provided in the multi-arm lever in the area of the axle allows the multi-arm lever to be displaced along the slotted hole recess so that the lever displacement described above is observed in the longitudinal extension of the slotted hole recess. This means that the basic positions mentioned above can be realized and converted particularly easily and functionally.

Thus, the pivot or bolt in question assumes a first final position within the slotted hole recess in the first basic position with the sensing element in deposit on both locking mechanism components. However, in the second basic position, in which the sensing element is arranged at a distance from both locking mechanism components, the pivot or bolt in question has a position in a second final position within the slotted hole recess. The same applies if the pawl does not assume its closed position in the first basic position.

In another advantageous variant, the multi-arm lever is rotatably mounted with its axis on a bolt or pivot connected to the pawl. In this case, the bolt or pivot that defines the axis, as described above, is not fixed to the lock housing or lock case. Rather, the bolt or pivot supporting the multi-arm lever or the sensing element is connected to the pawl and is subsequently moved along with the pawl.

As a result, a cut-out in the multi-arm lever that accommodates the bolt on the pawl acts as a pawl contour. This is because the cut-out follows the movement of the pawl and can therefore function as a pawl contour and thus detect the closing position of the pawl in connection with the sensing element or multi-arm lever. The two basic positions described above can also be realized and converted in this case. In the first basic position, the sensing element is deposited against the two locking mechanism components. Starting from this first basic position, a deviation of the pawl from its closed position causes the sensor to be biased. This is because the deviation of the pawl from its closed position in this variant corresponds to the fact that the pawl is lifted in relation to the rotary latch. This results in a pivoting movement of the sensing element or multi-arm lever, which remains in contact with the rotary latch and the pawl or is coupled to the pawl via the bolt or pivot. Nevertheless, this leads to the sensor being energized and thus to a signal that indicates the deviation of the locking mechanism component in question, in this case the pawl, from the closed position.

The same applies if the sensing element or the multi-arm lever assumes the second basic position, which corresponds to the sensing element or the multi-arm lever being arranged at a distance from both locking mechanism components. In this case, the sensor is also biased because the rotary latch has now left its closed position.

Another preferred variant is characterized by the fact that the multi-arm lever consists of two multi-arm lever parts that are rotatably mounted in relation to one another. These two multi-arm lever parts are preferably mounted coaxially to one another. It has also proven to be advantageous in this context if the two multi-arm lever parts are preloaded by a common spring for mutual deposit.

The two multi-arm lever parts can be designed in such a manner that one multi-arm lever part is equipped with the rotary latch contour that senses the rotary latch, while the other multi-arm lever part has the pawl contour that senses the pawl. For this purpose, the relevant multi-arm lever part is equipped with a pawl contour arm and additionally the sensor arm, i.e. designed as a two-arm lever. In contrast, the first mentioned multi-arm lever part only has a rotary latch contour arm.

Due to the spring provided between the two multi-arm lever parts, which pretensions both multi-arm lever parts for mutual deposit, it is possible to easily detect any pivoting movement or deviation of the pawl from its closed position starting from the first basic position with the sensing element or the multi-arm lever in deposit on both locking mechanism components. This is because such a deviation or lifted position of the pawl relative to the rotary latch in the first basic position causes the pawl contour arm to follow the pivoting movement of the pawl. The same applies to the sensor arm. As a result, the sensor interacting with the sensor arm is biased and detects the deviation of the pawl from its closed position in this first basic position.

If, on the other hand, the sensing element or the multi-arm lever is deposited against both locking mechanism components, the spring interposed between the two multi-arm lever parts ensures that the two multi-arm lever parts lie against one another. The same applies if the second basic position is assumed, in which the multi-arm lever is positioned at a distance from both locking mechanism components.

Finally, it has proven to be favorable in this context if the rotary latch contour is designed as a rotary latch contour nose. This allows the rotary latch contour nose in question, together with the associated contour arm, to follow any movements of the rotary latch and particularly deviations from its closed position particularly sensitively and effectively. All of this succeeds in terms of a functional and temperature-insensitive solution. In addition, there are no negative ageing effects to worry about. The same applies to any influences due to harmful environmental conditions, which also do not play a role according to the invention. These are the main advantages.

The invention is explained in greater detail below with reference to drawings which show only one exemplary embodiment and in which:

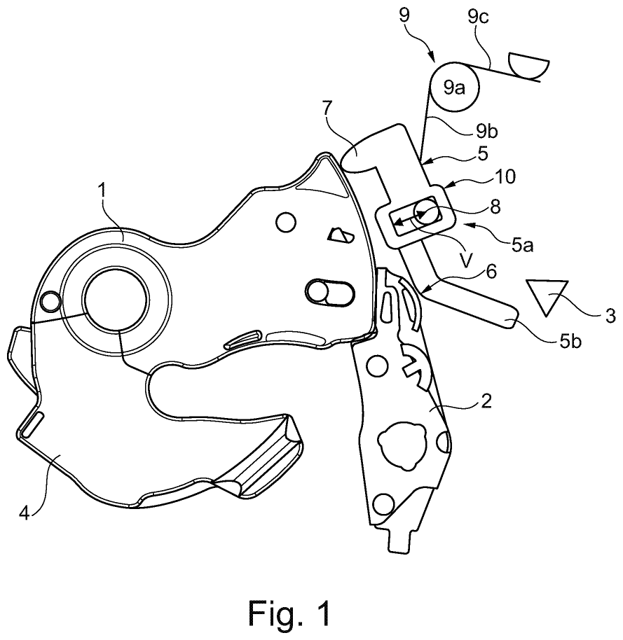

FIGS. 1 to 3 show a motor vehicle lock according to the invention in a first embodiment in different functional positions,

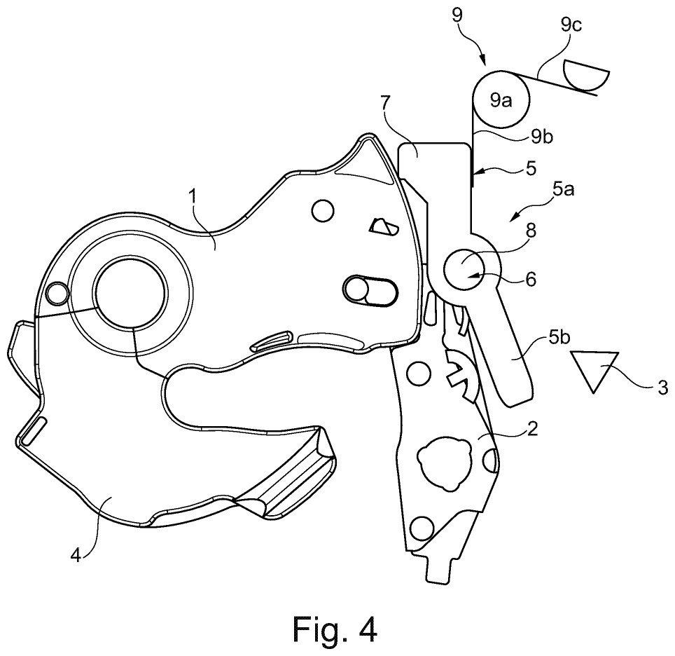

FIGS. 4 to 6 show the motor vehicle lock in a second embodiment in corresponding functional positions and

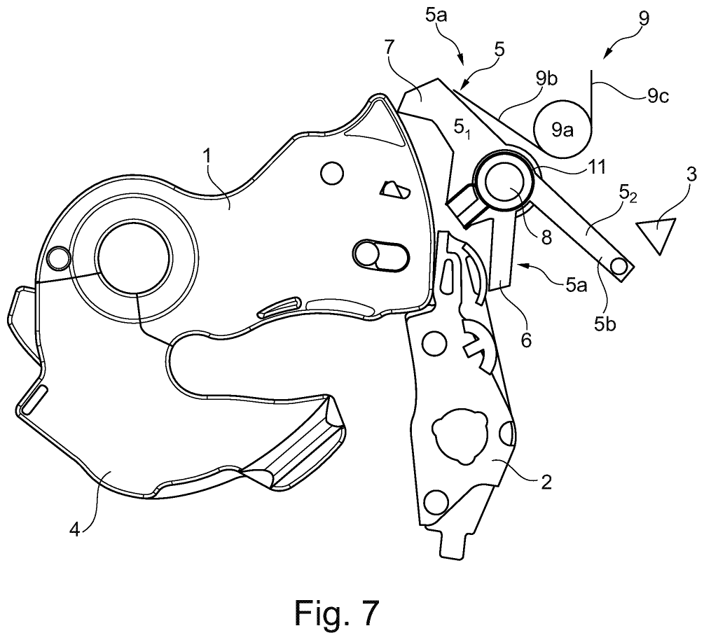

FIGS. 7 to 9 show a third embodiment in corresponding functional positions.

In the drawings, a motor vehicle lock is shown, which is a motor vehicle door lock. In its basic construction, this has a locking mechanism 1, 2 consisting substantially of rotary latch 1 and pawl 2 as locking mechanism components 1, 2. In addition, at least one sensor 3 is realized for position sensing of the rotary latch 1 and the pawl 2. The sensor 3 is only indicated schematically in the figures. In fact, the sensor 3 can be a tactile sensor such as a microswitch or a non-contact sensor 3 such as a Hall sensor. The rotary latch 1 is equipped overall with a plastic sheathing 4, which is only partially indicated and reproduced.

The basic construction also includes a sensing element 5, which is arranged between the sensor 3 and the associated locking mechanism components 1, 2, i.e. the rotary latch 1 and the pawl 2. For this purpose, the sensing element 5 is equipped with a pawl contour 6 and a rotary latch contour 7. The pawl contour 6 is used to sense a closed position of the pawl 2. The rotary latch contour 7 is used to detect a closing position of the rotary latch 1. The sensing element 5 is designed to rotate relative to an axis, wherein the axis in question is defined by a bolt or pivot 8. In addition, the sensing element 5 is pretensioned in the direction of the locking mechanism 1, 2 by means of a spring 9.

The spring 9 is designed to be stationary and, according to the exemplary embodiment, is designed as a spiral spring 9, which has a coiled spring portion 9a and two spring arms 9b, 9c extending from it. The coiled spring portion 9a may be attached to a pin or bolt that is made, for example, in one piece with a plastic housing that encloses the motor vehicle lock. The spring arm 9b extending from the coiled spring portion 9a is a spread-apart spring arm 9b of the spring 9, which is used to bias the sensing element 5. For this purpose, the relevant spring arm 9b rests against the sensing element 5 and defines a spring arm 9b. The remaining spring arm 9c rests against an indicated stop and is therefore designed as a stop spring arm 9c. The stop, like the pin or bolt holding the curved portion 9a, may also be molded onto the lock housing made of plastic, which is not shown in detail.

The sensing element 5 is designed as a multi-arm lever that can be rotated about the axis defined by the bolt or pivot 8. In fact, the multi-arm lever or sensing element 5 in question has at least one contour arm 5a and one sensor arm 5b. The at least one contour arm 5a has the pawl contour 6 and the rotary latch contour 7. The sensor arm 5b, on the other hand, is configured to interact with the sensor 3. If the sensor 3 is a microswitch, the sensor arm 5b ensures that the switch is actuated as required, as explained in more detail below. However, if the sensor 3 is a non-contact sensor, for example a Hall sensor, the sensor arm 5b is equipped with a permanent magnet whose approach corresponds to a signal from the sensor 3.

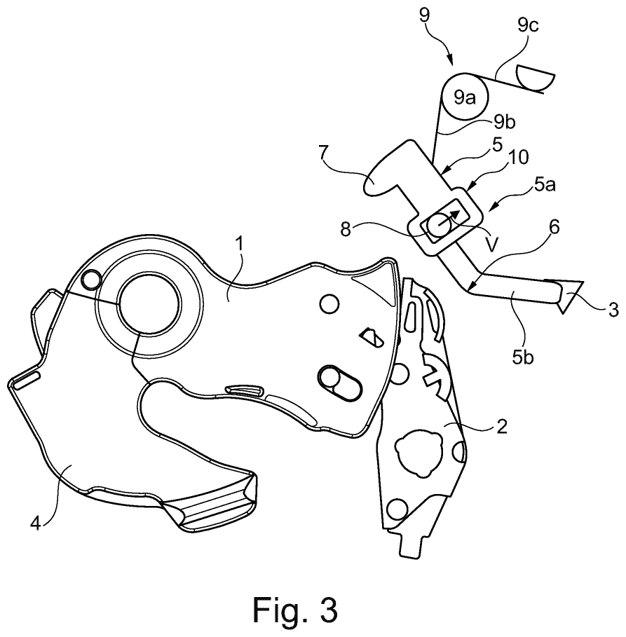

The first exemplary embodiment according to FIGS. 1 to 3 is equipped with the special feature that the multi-arm lever with contour arm 5a and sensor arm 5b or the sensing element 5 has a slotted hole recess 10 in the area of the axis defined by means of the bolt or pivot 8. Consequently, the slotted hole recess 10 in the area of the axis or the bolt or pivot 8 allows not only rotary movements of the multi-arm lever or sensing element 5, but also a lever displacement V, namely along or in its longitudinal extension. This lever displacement V is represented in FIGS. 1 and 3 and is ultimately determined by the path that the bolt or pivot 8 can travel within the slotted hole recess 10 in its longitudinal extension.

The representation in FIG. 1 shows that the sensing element or the multi-arm lever 5 is deposited on both locking mechanism components 1, 2. The closing position of the locking mechanism 1, 2 and consequently the closing position of both the rotary latch 1 and the pawl 2 correspond to this. In addition to this first basic position of the sensing element 5 shown in FIG. 1, it can also assume a second basic position, as shown in FIG. 3. In this case, the sensing element 5 is positioned at a distance from both locking mechanism components 1, 2. Now the locking mechanism 1, 2 assumes its pre-latching position and the pawl 2 engages with a pre-latch on the rotary latch 1.

In fact, the rotary latch 1 has a main latch and a pre-latch. In the representation shown in FIG. 1, the rotary latch 1 is located in the main latch because the pawl 2 has fallen into the relevant main latch. At the transition from FIG. 1 to FIG. 3, however, the rotary latch 1 has been moved slightly in the opening direction, i.e. clockwise around its axis, and the pawl 2 is located in the associated pre-latch of the rotary latch 1.

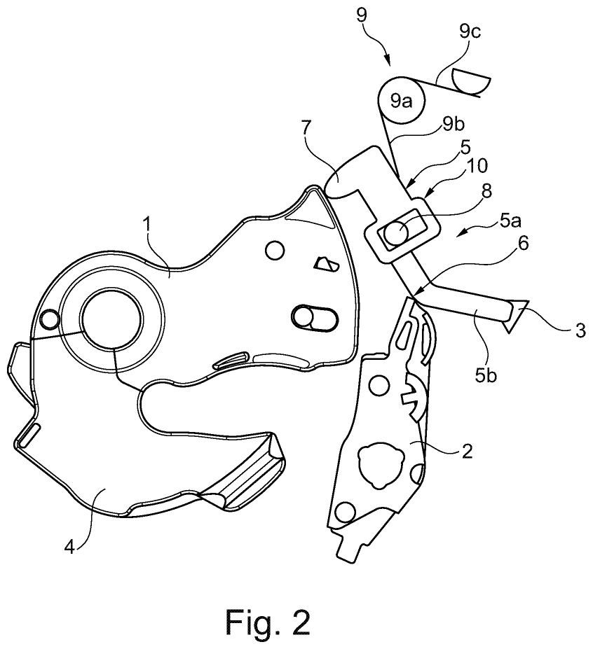

In FIG. 2, on the other hand, the situation is represented in which the rotary latch 1 has retained its main latch position as shown in FIG. 1, but the pawl 2 has been opened. Since FIG. 1 corresponds to the first basic position with the sensing element 5 in deposit on both locking mechanism components 1, 2, when the pawl 2 is lifted from the main latch position in accordance with the representation in FIG. 1 and during the transition from FIG. 1 to FIG. 2, the sensing element, which is still deposited against the two locking mechanism components 1, 2, is also pivoted by the pawl 2, which is pivoted clockwise in relation to the rotary latch 1, about its axis defined by the bolt or pivot 8. At the same time, the bolt or pivot 8 moves along the slotted hole recess 10, namely from a first end position in the slotted hole recess 10 shown in FIG. 1 in the direction of a second end position of the bolt or pivot 8 within this slotted hole recess 10.

Since during the transition from FIG. 1 to FIG. 2 the clockwise opening pawl 2 drives against the pawl contour 6 and the rotary latch contour 7 is held unchanged in plant on the rotary latch 1 with the aid of the spring 9, the sensor arm 5b can now interact with the sensor 3 during the transition from FIG. 1 to FIG. 2. This is because the sensing element 5 is pivoted counterclockwise as a result. Previously and in the representation according to FIG. 1, the sensor arm 5b was spaced apart from the sensor 3. As a result, the sensor 3 does not emit a signal in the closed position of both the rotary latch 1 and the pawl 2 as shown in FIG. 1.

If, however, starting from this first basic position in FIG. 1 with the sensing element 5 in deposit on both locking mechanism components 1, 2, the sensing element 5 has been pivoted counterclockwise about the bolt or pivot 8 during the transition from FIG. 1 to FIG. 2, the sensor arm 5b of the sensing element 5 can interact with the sensor 3 so that the sensor 3 sends a signal, for example to a control unit not shown. In contrast, no signal is emitted in the functional position shown in FIG. 1.

FIG. 3 now shows the second basic position, in which the sensing element 5 is at a distance from the two locking mechanism components 1, 2. This corresponds to the fact that the sensing element 5—based on FIG. 2—is pivoted even further counterclockwise, because the rotary latch contour 7 in this case is not (no longer) in contact with the rotary latch 1. This is because the rotary latch 1 is in the pre-latch position shown in FIG. 3. The pawl 2 has fallen into the pre-latch of the rotary latch 1. In this case too, the sensor arm 5b of the sensing element 5 ensures that the sensor 3 generates a signal and transmits it to the control unit, which is not shown.

Based on the functional sequences described, it is clear that the sensor 3 is layered and configured to query the position of the rotary latch 1 and the pawl 2. This is because FIG. 1 with rotary latch 1 in the closed position and pawl 2 corresponds to the fact that sensory system 3 does not emit a signal. However, any deviation of at least one of the two locking mechanism components 1, 2 from its closed position now ensures that the sensor 3 is biased. In the representation shown in FIG. 2, the rotary latch 1 is still in its closed position or main latch position. In contrast, the pawl 2 deviates from its closed position, namely it is open, which results in the sensory system 3 being biased as described. The same applies if the rotary latch 1 deviates from its closed position or main latch position, namely assumes the pre-latch position as shown in FIG. 3. In this case, the sensing element 5 also ensures that the sensor 3 generates a signal. In other words, any deviation of at least one of the locking mechanism components 1, 2 from its closed position biases the sensor 3, so that the non-biasing of the sensor 3 corresponds to both the rotary latch 1 and the pawl 2 safely assuming their closed position, as shown in FIG. 1. It is also clear that the sensor 3 is configured to query the position of both the rotary latch 1 and the pawl 2.

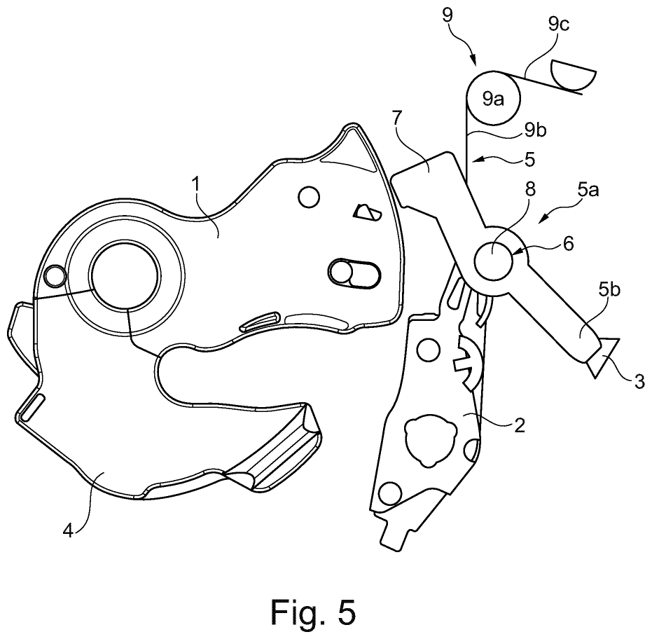

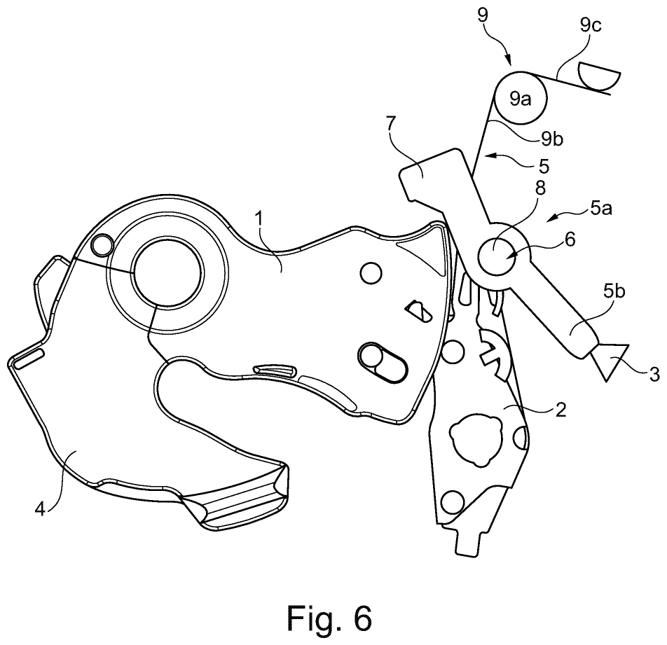

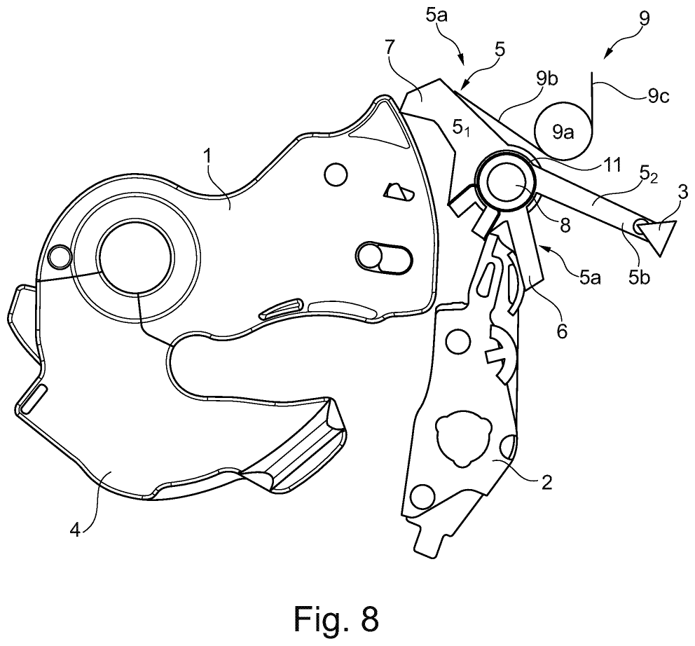

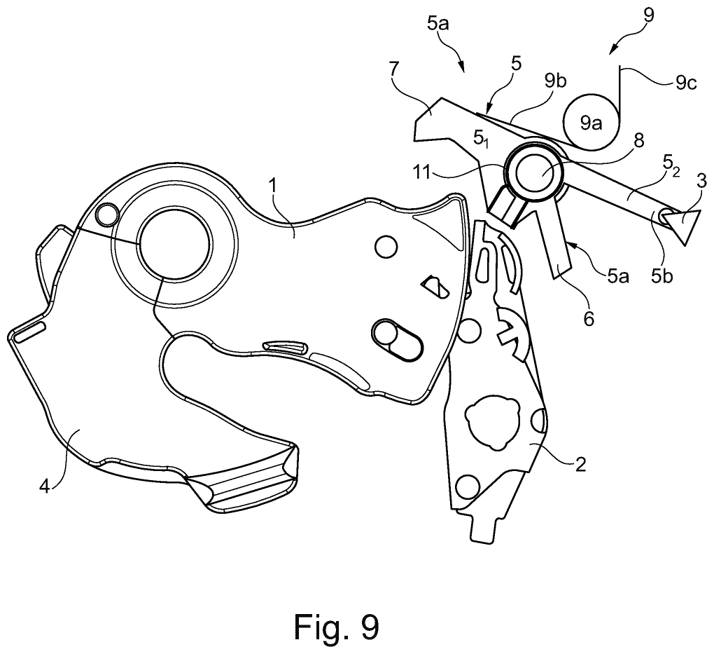

The two remaining exemplary embodiments shown in FIGS. 4 to 6 on the one hand and FIGS. 7 to 9 on the other hand proceed in a comparable manner. The representation in FIGS. 4 and 7 corresponds to that in FIG. 1, i.e. to the closed position of both the rotary latch 1 and the pawl 2. FIGS. 5 and 8, on the other hand, show a situation comparable to FIG. 2, i.e. with rotary latch 1 in the closed position and pawl 2 in the open position. FIGS. 6 and 9 finally correspond to the situation in which the rotary latch 1 assumes its pre-latch position and not the closed position, whereas the pawl 2 is closed, as shown in FIG. 3.

In a manner comparable to that shown above, FIGS. 4 and 7 each show the sensing element 5 in plant on both locking mechanism components 1, 2 in the first basic position. The second basic position with the sensing element 5 spaced apart from the two locking mechanism components 1, 2 is shown accordingly in FIGS. 6 and 9.

Looking now at the second exemplary embodiment according to FIGS. 4 to 6, the design at this location is such that the sensing element or the multi-arm lever 5 is rotatably mounted with its axis on the bolt or pivot 8, which in this case is connected to the pawl 2. For this purpose, the sensing element or the multi-arm lever has a cut-out receiving the bolt 8, which fulfills a dual function within the scope of the invention in that the cut-out also acts as a pawl contour 6. This is because the sensing element 5 can sense the closed position of the pawl 2 via the cut-out accommodating the bolt 8 or the pawl contour 6, as will be explained in more detail below with reference to this exemplary embodiment.

FIG. 4 represents the situation where the rotary latch 1 is in the main latch position and the pawl 2 is engaged. Both locking mechanism components 1, 2 therefore assume their closed position. In a first basic position, the sensing element 5 is deposited against the two locking mechanism components 1, 2. As a result, the sensor arm 5b of the sensing element 5 is positioned at a distance from the sensor 3 and consequently cannot interact with the sensor 3. As a result, the control unit, which evaluates the signals from the sensor 3 and is not shown, evaluates this to the effect that both locking mechanism components 1, 2 are safely in their respective closed position.

During the transition from FIG. 4 to FIG. 5, the sensing element 5 remains in deposit on the two locking mechanism components 1, 2. This is because the rotary latch contour 7 is still in contact with the rotary latch 1. The same applies to the pawl contour 6, which acts as a cut-out for the bolt or pivot 8. However, during the transition from FIG. 4 to FIG. 5, the pawl 2 has left its closed position and has been opened relative to the rotary latch 1. As a result, the sensing element 5 has performed a pivoting movement counterclockwise from FIG. 4 to FIG. 5 around the axis defined by the bolt or pivot 8, so that the sensor arm 5b interacts with the sensor 3. The sensor 3 therefore sends a corresponding signal to the control unit, which indicates that at least one of the locking mechanism components 1, 2 has left its closed position. This applies in particular to the open pawl 2.

The second basic position is now shown in FIG. 6 in that the sensing element 5 is positioned at a distance from both locking mechanism components 1, 2. This second basic position results in the transition from FIG. 5 to FIG. 6 in that the spring 9 continues to hold the sensing element 5 in deposit against the two locking mechanism components 1, 2. However, as the rotary latch 1 has assumed its pre-latch position during the transition from FIG. 5 to FIG. 6, there is a pivoting movement of the sensing element 5 in an anticlockwise direction or the sensor arm 5b continues to biased the sensor 3. In this case, the sensing element 5 also ensures that the sensor 3 is biased because at least one of the locking mechanism components 1, 2 deviates from its closed position, in this case the rotary latch 1 assumes its pre-latch position. In contrast, the pawl 2 is in its closed state.

If the third exemplary embodiment shown in FIGS. 7 to 9 is now considered, it can be seen that in this case the multi-arm lever or the sensing element 5 is composed of two multi-arm lever parts 5₁ and 5₂ which are rotatably mounted relative to one another. According to the exemplary embodiment, the two multi-arm lever parts 5₁ and 5₂ are mounted coaxially to one another. The bolt or pivot 8 defining the common axis is used for this purpose. It can also be seen that the two multi-arm lever parts 5₁, 5₂ are pretensioned by a common spring 1 1 for mutual deposit.

In fact, the spring 1 1 is again a spiral spring with a coiled portion surrounding the bolt or pivot 8 and two spring arms extending from it. The two spring arms ensure that the two multi-arm lever parts 5₁, 5₂ lie against each other, as shown in FIGS. 7 and 9. If, on the other hand, there is a relative movement between the two multi-arm lever parts 5₁ and 5₂ as shown in the representation in FIG. 8, the two spring arms are spaced apart and the spring 1 1 as a whole ensures that the two multi-arm lever parts 5₁, 5₂ are brought back to the functional position in FIG. 8 and deposited in plant with one another.

FIG. 7 shows the first basic position, in which the sensing element 5 is held in deposit on both locking mechanism components 1, 2. Both the rotary latch 1 and the pawl 2 each assume their closed position. The design is such that the rotary latch contour 7 is present on one multi-arm lever part 5₁, whereas the other second multi-arm lever part 5₂ has the pawl contour 6. In addition, the further second multi-arm lever part 5₂ is also equipped with the sensor arm 5b in addition to the pawl contour 6 and the associated contour arm 5a. It can be seen that two contour arms 5a are realized in this embodiment, namely the contour arm 5a with the pawl contour 6 on the multi-arm lever part 5₂ and the further contour arm 5a with the rotary latch contour 7 on the further multi-arm lever part 5₁.

The closing position of both the rotary latch 1 and the pawl 2 in the main latch position shown in FIG. 7 with closed pawl 2 corresponds to the previously described functional positions in FIGS. 1 and 4 in that the sensor arm 5b does not interact with the sensor 3. As a result, the control unit evaluating the signals from the sensor 3 can interpret this as a safe assumption of the closed position of both the rotary latch 1 and the pawl 2.

However, if during the transition from FIG. 7 to FIG. 8 the pawl 2 moves from its closed to its open position with the rotary latch 1 still in the main latch position, the pawl 2, which is pivoted clockwise in the opening direction, ensures that the sensing element 5 is still held in contact with both locking mechanism components 1, 2, but performs a pivoting movement. According to the exemplary embodiment in FIGS. 7 to 9, this pivoting movement corresponds to the multi-arm lever part 5₂ being pivoted relative to the multi-arm lever part 5₁, wherein the spring 1 1 preloading the two multi-arm lever parts 5₁, 5₂ is preloaded at the same time.

As a result, the sensor arm 5b is moved towards the sensor 3 and ensures that the sensor 3 emits a signal in this case. Again, the sensor 3 is biased because at least one locking mechanism component 1, 2, in this case the pawl 2, has deviated from its closed position, i.e. has been opened. This is because during this opening movement of the pawl 2, the pawl contour 6 is biased and thus the contour arm 5a, which together with the sensor arm 5b defines and describes the multi-arm lever part 5₂ as a whole.

At the transition from FIG. 8 to FIG. 9, the rotary latch 1 moves from its main latch position to the pre-latch position and the pawl 2 is engaged. In this case, too, at least one of the two locking mechanism components 1, 2 deviates from its closed position, namely the rotary latch 1, which is in the pre-latch position. This in turn causes the sensor 3 to be biased. This is because in the functional position shown in FIG. 9, the second basic position of the sensing element 5 is observed at a distance from both locking mechanism components 1, 2. This can be attributed to the fact that, starting from the functional position shown in FIG. 8, the spring 9 holds the rotary latch contour 7 in position against the rotary latch 1.

However, as the rotary latch 1 has moved to its pre-latch position during the transition from FIG. 8 to FIG. 9, the rotary latch contour 7—biased by the spring 9—can no longer be supported on the rotary latch 1. As a result, the multi-arm lever part 5₂, which has the rotary latch contour 7, moves biased by the spring 1 1 in the direction of the multi-arm lever part 5₂, which lie against one another in the functional position shown in FIG. 9. In this position, the spring 1 1 ensures that the two multi-arm lever parts 5₁ and 5₂ are deposited against one another. In this case, the sensor 3 also emits a signal because the rotary latch 1 has assumed its pre-latch position and consequently the deviation to be sensed from the closed position of the rotary latch 1 is observed, namely from the main latch position.

It can be seen in all the figures that the rotary latch contour 7 is designed as a rotary latch contour nose 7 for sensing the position of the rotary latch 1. In contrast, the pawl contour 6 in the exemplary embodiment according to FIGS. 1 to 3 is an arc or a bent contour of the sensing element 5. In the variant shown in FIGS. 4 to 6, the pawl contour 6 is designed as a cut-out in the sensing element 5 that accommodates the bolt 8. Finally, the pawl contour 6 in the further exemplary embodiment according to FIGS. 7 to 9 is a separate arm or a separate contour arm 5a. By contrast, in the other two exemplary embodiments shown in FIGS. 1 to 3 on the one hand and FIGS. 4 to 6 on the other, the contour arm 5a is designed in such a manner that it has both the pawl contour 6 and the rotary latch contour 7.

### LIST OF REFERENCE NUMBERS

1, 2 locking mechanism components
1 rotary latch
2 pawl
3 sensor
4 plastic sheathing
5 sensing element, multi-arm lever
5a contour arm
5b sensor arm
6 pawl contour
7 rotary latch contour (nose)
8 bolts or pivots
9 spring (coil spring)
9a spring portion
9b, c spring arms
10 slotted hole recess
11 spring
V lever displacement

1. A motor vehicle lock comprising:
a locking mechanism having locking components including at least a rotary latch and a pawl,
at least one sensor for sensing a position of the rotary latch and the pawl,
at least one sensing element positioned between the sensor and an associated one of the locking mechanism components, and
a spring,
wherein the sensing element is equipped with a pawl contour for sensing a closed position of the pawl and a rotary latch contour for sensing a closed position of the rotary latch, wherein the sensing element is rotatable relative to an axis, and wherein the sensing element is biased towards the locking mechanism by the spring, and
wherein the spring has a spread-apart spring arm configuration, and the spring is stationary and biases the sensing element with the spread-apart spring arm.

2. The motor vehicle lock according to claim 1, wherein the spring is a spiral spring with a coiled spring portion, and the spread-apart spring arm configuration includes first and second spring arms extending from the coiled spring portion.

3. The motor vehicle lock according to claim 2, wherein the first spring arm is a sensing spring arm acting on the sensing element and the second spring arm is a stop spring arm resting against a stop.

4. The motor vehicle lock according to claim 1, wherein the sensing element is a multi-arm lever rotatable about the axis and having at least a contour arm and a sensor arm, wherein the contour arm has the pawl contour and the rotary latch contour and the sensor arm is configured to interact with the sensor.

5. The motor vehicle lock according to claim 4, wherein the multi-arm lever has a slotted hole recess in an area of the axis which, in addition to rotary movements, also permits a lever displacement of the multi-arm lever in a direction of longitudinal extension of the slotted hole recess.

6. The motor vehicle lock according to claim 4, wherein the multi-arm lever is rotatably mounted with the axis on a bolt or pivot connected to the pawl.

7. The motor vehicle lock according to claim 6, wherein the multi-lever arm has a cut-out that receives the bolt on the pawl and functions as the pawl contour.

8. The motor vehicle lock according to claim 4, wherein the multi-arm lever includes two multi-arm lever parts which are rotatably mounted relative to one another.

9. The motor vehicle lock according to claim 8, wherein the two multi-arm lever parts are pretensioned by a second spring.

10. The motor vehicle lock according to claim 1, wherein the rotary latch contour is shaped as a contour nose.

11. The motor vehicle lock according to claim 8, wherein the two multi-arm lever parts are mounted coaxially relative to one another.

12. The motor vehicle lock according to claim 8, wherein the two multi-arm lever parts include a first multi-arm lever part that includes the rotary latch contour and a second multi-arm lever part that includes the pawl contour.

13. The motor vehicle lock according to claim 3, further comprising a lock housing, wherein coiled spring portion is attached to a pivot in the lock housing, and the lock housing is the stop for the stop spring arm.

14. The motor vehicle lock according to claim 1, wherein the sensor is a tactile switch.

15. The motor vehicle lock according to claim 1, wherein the sensor is a Hall sensor, and the sensing element includes an embedded magnet opposite from the Hall sensor.

16. The motor vehicle lock according to claim 4, wherein the rotary latch has a main latch position and a pre-latch position, and in the main latch position the sensing element is in contact with both the rotary latch and the pawl, and in the pre-latch position the sensing element is at a distance from the rotary latch and the pawl.

17. The motor vehicle lock according to claim 15, wherein in the main latch position, the sensing element is at a distance from the sensor, and the sensing element is positioned to interact with the sensor when at least one of the rotary latch or the pawl is moved from the closed position.
